(19) United States
(12) Patent Application Publication
(10) Pub. No.: US 2008/0209473 A1
(43) Pub. Date: Aug. 28, 2008

(54) Method and Apparatus for Building an Electronic Program Guide Based on Channel Profiles

(75) Inventor: Marcin Zbigniew Gramza, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/574,553

(22) PCT Filed: Sep. 1, 2005
(86) PCT No.: PCT/IB05/52869

§ 371 Date: Mar. 1, 2007

Related U.S. Application Data
(60) Provisional application No. 60/606,677, filed on Sep. 2, 2004.

(51) Int. Cl. G06F 3/00

(52) U.S. Cl. 725/44

(57) ABSTRACT

A method and apparatus for building an electronic programming guide based on statistical information about the history of broadcasted programs where the programming information is obtained on the basis of currently available schedule information and where a broadcast system spreads programming information across a plurality of transport streams. Each time a user changes a channel, a new transport stream potentially becomes available, and current scheduling information is taken from that stream to update a profile of programming for that particular stream. New programming information that is transmitted on other channels is stored whenever the user selects one of those channels. In this manner, an electronic programming guide is eventually built based on the programming information available on the channels accessed by the user.

The invention generally relates to the analysis of broadcast programming. More specifically, the invention is directed to a method and apparatus for analyzing broadcast programming schedules over an extended period of time to compile an electronic guide to speed user access to desired program types.

The rapid growth in the number and types of broadcast programming over such media as satellite, cable and internet provides the consumer with almost limitless choices. While the availability of plentiful and varied programming is a boon to the consumer, the ever-increasing number of available channels has made accessing a desired type of programming increasingly difficult. Printed guides, which were effective when there were only three major television networks and a handful of local channels, are no longer practical. With the potential for hundreds of available channels, printed guides are both impractical to produce and update and equally difficult to use. For instance, to find which weeknights and at what times a particular type of program might be airing could involve scanning through hundreds of listings.

Programming guides broadcast by service providers such as scrolling listings showing a window of television programming for the next several hours are also burdensome. They require the user to watch attentively while dozens of programming choices scroll up the screen. Meanwhile, the user must either possess a very good memory or otherwise take note of possible desired programming, channel indicator and times, while the list continues to scroll. Many viewers of television programming (and listeners of audio programming) prefer instead to “channel surf,” i.e. to manually scroll through channels, stopping on whatever appeals to the user at the time. This method, while popular, is inefficient and frustrating. With so many channels from which to choose, often a user will settle on the first selection that seems appealing, without having clicked through all available choices, preferring the “bird in the hand” to expending additional time to see if anything more desirable is being broadcast elsewhere.

A more orderly presentation of programming options is needed. A useful device would allow the user to continue the practice of channel surfing, but would allow one to surf only those channels that have the type of programming of interest to the viewer, skipping over dozens or hundreds of channels of no interest to the viewer. Likewise, a device that could present a schedule of upcoming programming, but only for desired types of programs would be far more useful than the present scrolling screen programming guide showing all possible channels.

Such devices are known in the art. For example, devices are known that allow a user to select a particular topic or genre of interest, and then to incrementally scan the currently available programs that are likely to be of that topic or genre. Such devices can make use of a list builder where the device has access, for example, to an information source that provides the time of each scheduled program on each channel and an indication of each program's topic or genre.

One difficulty with creating an electronic list is that programming information is not always available from one source channel or transport stream. In order for a device to build a complete list of all channels where programming information is broadcast, the information must be accessed and updated on a regular basis. One way to do this is for the device to regularly scan through all channels containing programming information. Such systems are known in the art. A drawback of this design is that it is a time-consuming process to scan through all the channels broadcasting programming. For example, to collect the electronic programming guide information on the channels broadcast by the ASTRA satellite would require tuning to more than 60 transport streams. Either the user is inconvenienced while this process takes place, or the list building device must have separate means for receiving different channels than the one being accessed by the user. This requires the cost of extra space, greater power consumption and price of additional equipment.

According to an aspect of the invention, a method and apparatus are disclosed for building an electronic programming guide based on statistical information about the history of broadcasted programs. Programming information is obtained on the basis of currently available schedule information. The invention is directed to broadcast systems where programming information is spread across a plurality of transport streams. Each time a user changes a channel, a new transport stream potentially becomes available, and current scheduling information is taken from that stream to update a profile of programming for that particular stream. New programming information that is transmitted on other channels is stored whenever the user selects one of those channels. In this manner, an electronic programming guide is eventually built based on the programming information available on the channels accessed by the user.

The invention includes a programming history builder that can be used to predict the likelihood of the types of programming available on a particular channel at a particular time of the day. The electronic programming history can then be used either to allow the user to surf through only the channels likely to be broadcasting the type of program the user wishes to access, or, for example, to provide a display of likely programming on selected channels or a display of which channels are likely to be airing particular types of programming.

The invention is best understood from the following detailed description when read with the accompanying drawing figures.

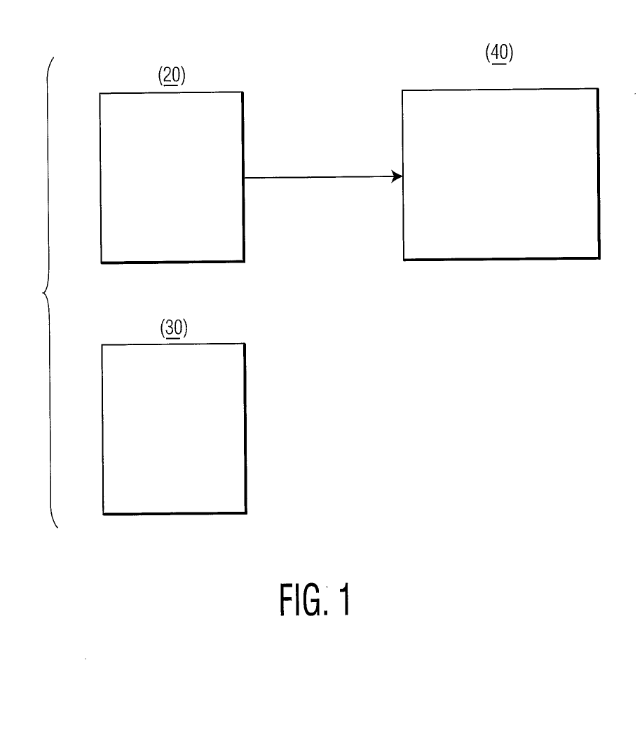

FIG. 1 illustrates programming information that is broadcast piecemeal over a plurality of transport streams.

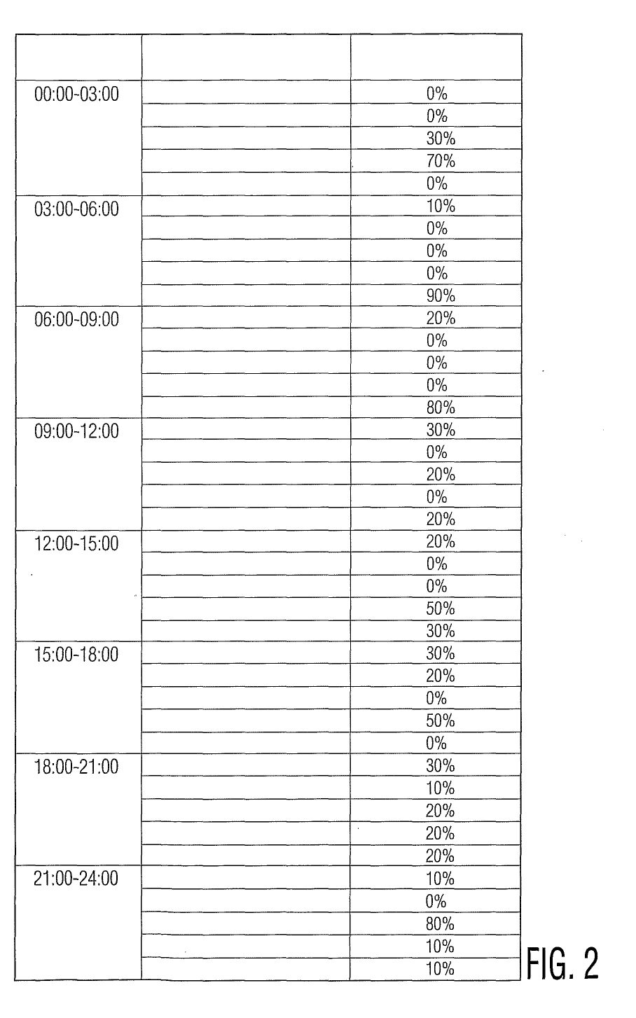

FIG. 2 illustrates an example of a channel profile developed according to the invention.

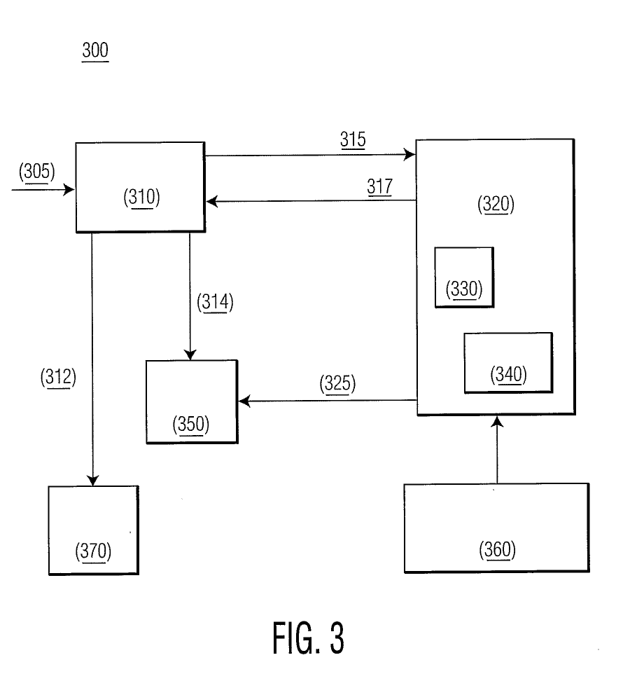

FIG. 3 is a block diagram of a television system including a device for creating and applying an electronic programming guide.

FIG. 3a is a block diagram of a set-top box system including a device for creating and applying an electronic programming guide.

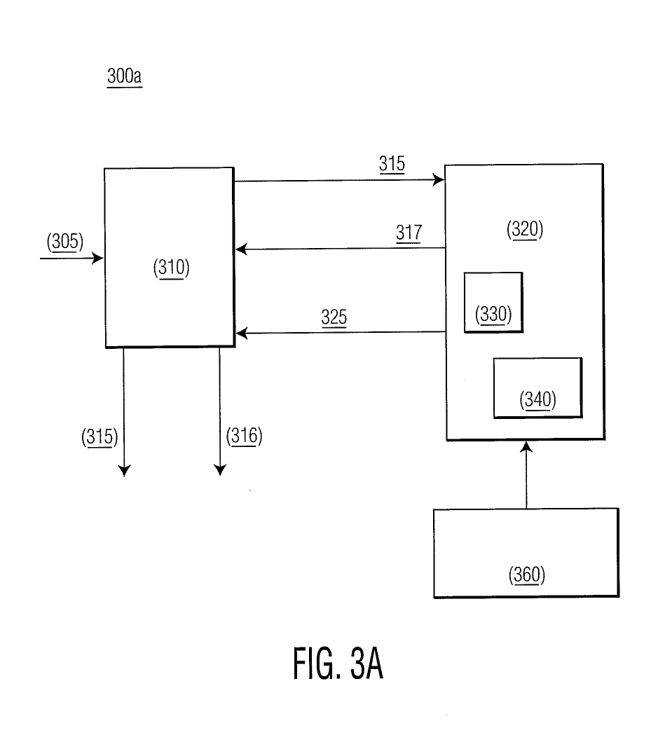

FIG. 4 illustrates an example of a process flow diagram for building an electronic programming guide by accessing programming information from channels selected by the user.

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

FIG. 1 illustrates the problem with broadcast systems that have programming information distributed across a number of transport streams. If a user is tuned to transport stream 1 (20) the receiver (40) only has access to the programming information for the channels that are sent on transport stream 1. Programming information for other channels, for example those depicted in block 30, is not available to the receiver, hence the user has no information about those channels unless the user stops accessing the current channel and switches to the channel broadcast on transport stream 2.

According to an aspect of the invention, the problem of broadcast systems that send programming information over a plurality of channels is solved by storing programming information available from the channel currently being accessed by the user. Over time, as the user selects different channels that broadcast programming information, it is possible to build up a historical picture of programming for all of the channels for which programming information is broadcast. The data acquired can then be compiled on a running basis to form statistical information about the types of programming available on each channel and at selected times.

FIG. 2 illustrates an example of a channel profile built up by acquiring programming information about that channel over time. In this example, daily programming is broken down into three-hour segments. For each segment, the likelihood of particular types of programming is compiled from the historic data. For example, in the 00:00 to 3:00 time slot, there is a 0% chance of news or sports programming, reflecting the fact that for the period of time for which programming data is available, neither news nor sports programming was broadcast for this time slot. This information could be used in a variety of ways, such as presenting the user with a graphical display of programming likelihood for particular channels or presenting the user with a display of which channels are most likely to be broadcasting particular types of programming. Such information could also be used to allow the user to surf channels with high likelihoods of broadcasting a preferred program type at the current time.

FIG. 4 shows an example of a process flow for building statistical programming information by acquiring programming information when the user accesses channels.

At step 410 it is determined whether the user has selected a new channel on the receiving device, which for purposes of illustration can be a television. If a new channel has not been selected, at decision point 415, it is determined whether the current channel has been in use longer than a threshold time period. The reason for this test is that after a predetermined time period, new programming information will be available on the currently selected channel. If new channel has not been selected and a threshold time period has not elapsed with the current channel active, the process loops back to step 410 until a new channel is selected or sufficient time has elapsed with the current channel active. Once a new channel has been selected, at decision branch 420 it is determined whether the channel selected transmits programming information. If no programming information is transmitted on the selected channel, the process flow is back to the starting point (410) to wait for a new channel selection. If it is determined at step 420 that the channel does transmit programming data, process flow proceeds to step 430. At step 430 it is determined whether programming information available from this channel has already been stored within a set time period. For example, if programming information is updated every hour, there is no point to re-storing programming information if the user has just returned to this channel after only several minutes since the information will not have changed. An alternative to using a fixed time period to determine whether to update the stored programming data would be to compare the programming data currently available from this channel with the data obtained the last time the channel was accessed.

If the outcome of decision point 430 is that there is new programming data available, the new data is stored at step 440 and used to update statistical information about the channels for which programming information is available on the currently selected channel at step 450. Process flow then returns to decision point 410 to wait for a new channel selection or for a set time period to have elapsed within which the user has not changed the channel.

At a minimum, the programming data available from the transport stream should include the channel number, the start and end time for the program and the type of programming.

A device for processing broadcast programming data in accordance with the invention could be a processor already associated with the receiving device, that already has the capability to access the data format of the received programming information. In an alternative embodiment, a separate processor could be dedicated to handling programming information. Such a processor would have to have access to a digital data stream from the receiver and be capable of decoding programming information from that data stream.

In order for statistical data obtained to be useful, the processor that has acquired and analyzed the data must have access to a display or be capable of using the data to provide genre-specific channel surfing, or both. If the processor is already part of the receiving device, e.g. a digital television, then the statistical programming information can be displayed directly on the television screen, either on whole screen or a portion of the screen, thus allowing the user to continue viewing one channel while perusing viewing options.

A television system incorporating a processor for acquiring and analyzing channel information data as described herein is shown in block diagram form in FIG. 3. A television signal (305) containing many channels of television broadcasts is received by a receiver, 310. The receiver converts the television signal from an individual channel to audio (312), video (314) and digital data (315) signals. The digital data signal includes channel programming information if such information is broadcast on the channel being received by the receiver. Channel data processor (320) incorporates a microprocessor (“MPU”) (330) for performing operations on the digital data, and a memory (340) for storing and processing channel programming information. The MPU performs the exemplary process steps described herein and illustrated in the flow diagram in FIG. 4 for creating channel programming statistics for an electronic programming guide. In the example depicted in FIG. 3, the Channel Data Processor is capable of producing a video image of the electronic programming guide. The programming guide video signal (325) is connected to video display 350 and the electronic programming guide can be displayed on video display 350 selectively under control of the Channel Data Processor.

In the exemplary system shown in FIG. 3, the user can access electronic programming guide information that has been generated by the MPU by using the Channel Selection User Interface (360), which can be a part of the television set or, preferably, a separate remote control. Upon receiving a command to display programming information, the Channel Data Processor will produce a video signal containing the information for display on the video display. The Channel Data Processor also has a connection (317) to the receiver for selecting the channel to be received.

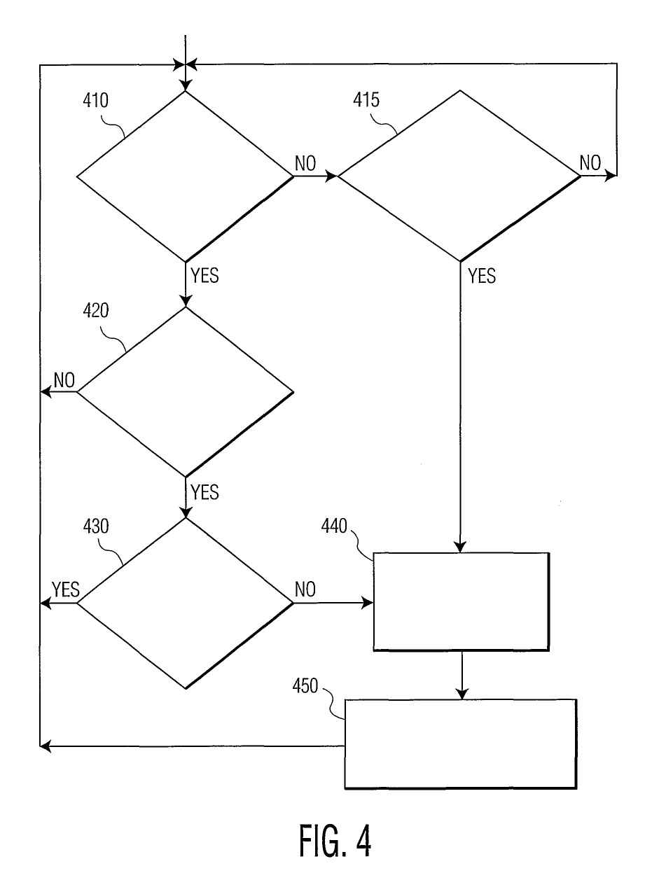

It is also possible, as illustrated in FIG. 3a, for the Channel Data Processor to be part of a “set-top box,” which incorporates elements 320, 330, 340 and 360 of FIG. 300, but also includes receiver 310. In this configuration, the television signal 305 goes to the set-top box, which produces video and audio outputs 315 and 316, which are connected to a monitor or a television set with inputs for audio and video. An advantage of the set-top box is that a consumer does not have to purchase a new television set to have the benefits of the electronic programming guide.

It is also possible for the Channel Data Processor not to have access to display means, but rather, to just have access to channel selection circuitry. In response to commands from the user to step through all channels with a particular type of programming, the processor can access it's statistical database for the current time slot and give commands selecting only those channels that have a high likelihood of containing the desired programming.

It is also possible for the electronic programming guide information to be displayed on a display incorporated in a remote control device for making channel selections. This requires the Channel Data Processor to have means for transmitting the electronic programming guide information to the remote control, such as by infra-red or radio frequency data transmission.

In accordance with another aspect, the subject invention comprises a program storage medium that constrains operation of the associated processors. Exemplary computer readable storage devices include conventional computer system RAM (random access memory), ROM (read only memory), EPROM (erasable, programmable ROM), EEPROM (electrically erasable, programmable ROM), flash memory, and magnetic or optical disks or tapes. Exemplary computer readable signals, whether modulated using a carrier or not, are signals that a processor hosting or running the program may be configured to access, including signals downloaded through the Internet or other networks. Examples of the foregoing include distribution of the program(s) on a CD ROM or via Internet download.

In the form of processes and apparatus implemented by digital processors, the associated programming medium and computer program code is loaded into and executed by a processor, or may be referenced by a processor that is otherwise programmed, so as to constrain operations of the processor and/or other peripheral elements that cooperate with the processor. Due to such programming, the processor or computer becomes an apparatus that practices the method of the invention as well as an embodiment thereof. When implemented on a general-purpose processor, the computer program code segments configure the processor to create specific logic circuits. Such variations in the nature of the program carrying medium, and in the different configurations by which computational and control and switching elements can be coupled operationally, are all within the scope of the present invention.

The foregoing discussion of the invention has been presented for purposes of illustration and description. Further, the description is not intended to limit the invention to the form disclosed herein. Consequently, variations and modifications commensurate with the above teachings and with the skill and knowledge of the relevant art are within the scope of the present invention. The embodiment described herein above is further intended to explain the best mode presently known of practicing the invention and to enable others skilled in the art to utilize the invention as such, or in other embodiments, and with the various modifications required by their particular application or uses of the invention. It is intended that the appended claims be construed to include alternative embodiments to the extent permitted by the prior art.

1. A method for analyzing broadcast programming, wherein broadcast programming information containing channel designation, program time period and program type information is broadcast over a plurality of channels, comprising the steps of:
determining (410) that a first channel of said plurality of channels has been selected by a user;
determining (420) whether said first channel contains broadcast programming information;
storing (440) said broadcast programming information if said first channel contains broadcast programming information;
calculating (450) statistical probabilities for programming types being broadcast at given times for those channels for which programming information is available on said first channel;
waiting for a second channel of said plurality of channels to be selected; and
repeating steps previous steps of the method for said second selected channel of said plurality of channels.

2. The method of claim 1 wherein step waiting step also includes determining whether new programming information is available from said first channel while waiting for a second channel of said plurality of channels to be selected; and if said new programming information is available:
storing said new programming information;
recalculating said statistical probabilities.

3. The method of claim 1 further comprising the step of:
calculating a reliability indicator for each channel based on the amount of programming information that has been stored and used to calculate said statistical probabilities for programming types for the channel.

4. The method of claim 1 further comprising the step of:
displaying said statistical probabilities for programming types.

5. The method of claim 1 further comprising the steps of:
receiving a user request to sequentially select channels of a desired program type;
accessing said statistical probabilities for programming types for all channels for which said statistical probabilities have been stored; and
selecting only those channels with statistical probabilities for the desired programming type above a predetermined threshold.

6. A device (300, 300a) for analyzing broadcast programming wherein broadcast programming information containing at least channel designation, program time period and program type information is broadcast over a plurality of channels, the device (300, 300a) comprising:
a processor (330) for receiving broadcast programming information from a receiver (310), and for performing calculations on said stored broadcast programming information; and
a memory (340) for storing said broadcast programming information.

7. The device (300, 300a) of claim 6, further comprising:
a display (350) for displaying results of said calculations performed on said stored broadcast programming information.

8. The device (300, 300a) of claim 6, wherein said processor (330) for receiving broadcast programming information also responds to user commands.

9. The device (300, 300a) of claim 8 wherein said processor (330) for receiving broadcast programming information also cooperates with said receiver (310) to make channel selections in response to said user commands.

10. The device (300, 300a) of claim 9 wherein said channel selections are limited to channels for which said stored broadcast programming information indicates that a channel has a likelihood of broadcasting a particular programming type selected by the user.

11. A computer readable medium for controlling operation of a processor capable of reading broadcast programming information comprising:
code (410) for determining that a first broadcast channel has been selected by a user;
code (420) for determining whether said first channel contains broadcast programming information;
code (440) for storing said broadcast programming information if said first channel contains broadcast programming information;
code (450) for calculating statistical probabilities for programming types being broadcast at given times for those channels for which programming information is available on said first channel;
code for determining when a second broadcast channel has been selected by the user; and
code for causing code elements determining code, storing code and calculating code to be re-executed for said second broadcast channel if a second broadcast channel has been selected.

12. A device (300, 300a) for analyzing broadcast programming wherein broadcast programming information containing at least channel designation, program time period and program type information is broadcast over a plurality of channels, the device (300, 300a) comprising:
first means (410) for determining that a first broadcast channel has been selected by a user;
second means (420) for determining whether said first channel contains broadcast programming information;
third means (440) for storing said broadcast programming information if said first channel contains broadcast programming information;
fourth means (450) for calculating statistical probabilities for programming types being broadcast at given times for those channels for which programming information is available on said first channel;
fifth means for determining when a second broadcast channel has been selected by the user; and
sixth means for causing said second broadcast channel to be processed by the second, third, and fourth means if a second broadcast channel has been selected.
